(19) United States
(12) Patent Application Publication
(10) Pub. No.: US 2023/0229009 A1
(43) Pub. Date: Jul. 20, 2023

(54) METHOD AND APPARATUS FOR DISTRIBUTING LANDMARK POSITIONS IN A POSITIONAL TRACKING SYSTEM

(71) Applicant: Six Degrees Space Ltd, Jerusalem (IL)

(72) Inventor: Daniel GREENSPAN, Jerusalem (IL)

(21) Appl. No.: 18/154,867

(22) Filed: Jan. 16, 2023

Related U.S. Application Data
(60) Provisional application No. 63/299,991, filed on Jan. 16, 2022.

(51) Int. Cl. G02B 27/01; G02B 27/02; G06T 19/00

(52) U.S. Cl. CPC G02B 27/0176; G02B 27/024; G06T 19/006; G02B 2027/0178

(57) ABSTRACT

A fixed map augmented reality system includes at least one beacon, a detector on a headset and a displayer. The beacon is mounted on or integrated with a physical element and emits light modulated with fixed map data related to a location of the light-emitting element of the physical element. When viewing the beacon, the detector decodes the modulated light into the fixed map data and determines a physical relationship of the beacon with respect to the detector. The displayer uses the physical relationship to generate a display overlay on the headset of the fixed map data related to the physical element. The display overlay includes a human-readable message of data related to the physical element and a display connection connecting the human-readable message to a location in a frame-of-reference associated with the physical element.

### CROSS REFERENCE TO RELATED APPLICATIONS

This application claims priority from U.S. provisional patent application 63/299,991, filed Jan. 16, 2022, which is incorporated herein by reference.

### FIELD OF THE INVENTION

The present invention relates to augmented reality systems generally and to positional tracking in such systems in particular.

### BACKGROUND OF THE INVENTION

Many techniques exist for positional tracking based on observed landmarks. For example, lighthouses are traditionally used for sea navigation and they are powerful emitters of visible light.

In the field of augmented reality (AR), the six degree of freedom (6DOF) pose (position and orientation) of the AR viewing device (headset, handset, or otherwise) is typically determined in real time by analyzing the observed position of landmarks with respect to the specified position of these landmarks on a map.

In many cases, the map describing landmarks and their locations can be dynamically generated by a process such as SLAM (Simultaneous Localization And Mapping).

It will be clear that in the case of multiple systems independently building a map, differing representations will typically occur. For example, the SLAM algorithm may define the nearest corner of the nearest visible building to be at the origin (i.e., location (0,0,0)). The SLAM algorithm may alternatively receive a position from a GPS (Global Positioning System) measurement device. This GPS position may be unstable when used indoors. In both such cases, multiple identical SLAM algorithms starting from slightly different locations may build maps that, although similar, are not identical.

Thus, in the case of an AR environment extending beyond a single device, some details of the map (for example the shape and position of the landmarks) must be shared, in order that virtual objects displayed or specified as being in a specific location in the physical world in one device will be displayed as being in the same location in the physical world in other devices.

The data transfer, ownership, and responsibility for such map data is fraught with multiple issues, relating to data security, privacy and trust, communication network aspects, and so forth. Such map data is often at the mercy of competing commercial interests offering competing “Metaverses”.

In many situations, the landmarks may not be conventional buildings, but may be key physical points such as the corners and key intersection points of the metal struts of a vehicle or machine. Such landmarks must be described in a frame of reference that may move within other (e.g. global) frames of reference.

### SUMMARY OF THE PRESENT INVENTION

There is therefore provided, in accordance with a preferred embodiment of the present invention, a beacon for an augmented reality system. The beacon includes a light emitting unit and a modulator. The light emitting unit emits light and is mounted on or integrated with a physical element. The modulator modulates the light with data related to the physical element. The data includes status data related to a status of the physical element and position data regarding a location of the light emitting unit in a frame of reference (FoR) related to the physical element.

Moreover, in accordance with a preferred embodiment of the present invention, the data also includes marker data related to a marker location within the FoR.

Further, in accordance with a preferred embodiment of the present invention, the marker data or the status data includes an internet link.

Still further, in accordance with a preferred embodiment of the present invention, the modulator provides non-human-readable modulation.

Moreover, in accordance with a preferred embodiment of the present invention, the beacon includes a storage unit storing an ID for the FoR, and at least one of: the position data and the marker data.

There is also provided, in accordance with a preferred embodiment of the present invention, a detector located on a headset for an augmented reality system. The detector includes a light detector, a decoder, a processing unit and a displayer. The light detector captures multiple measurements of modulated light received from multiple angles. The modulated light is emitted by at least one beacon mounted on or integrated with a physical element viewable in a direction the headset faces. The decoder decodes the modulated light into data related to the physical element. The processing unit determines from the multiple angles a physical relationship of the at least one beacon with respect to the detector. The displayer uses the physical relationship to generate a display overlay on the headset of the data related to the physical element. The display overlay includes at least one display connection to the at least one beacon.

Moreover, in accordance with a preferred embodiment of the present invention, the data includes at least one of: status data related to a status of the physical element, position data regarding a beacon location of the at least one beacon in a frame of reference (FoR) related to the physical element, and marker data and marker location data related to at least one marker location within the FoR.

Further, in accordance with a preferred embodiment of the present invention, the data includes an interne link.

Still further, in accordance with a preferred embodiment of the present invention, the at least one beacon is three or more beacons and the physical element is a rigid element.

Additionally, in accordance with a preferred embodiment of the present invention, the display overlay includes a human-readable message of the data connected to the at least one display connection.

Moreover, in accordance with a preferred embodiment of the present invention, the display overlay includes, for at least one beacon location of the three or more beacons, a human-readable message of the status data related to the beacon location connected by the at least one display connection to the beacon location.

Further, in accordance with a preferred embodiment of the present invention, the display overlay includes, for the at least one marker location, a human-readable message of the marker data connected by the at least one display connection to the marker location.

Still further, in accordance with a preferred embodiment of the present invention, the at least one display connection is a pointed arrow.

Moreover, in accordance with a preferred embodiment of the present invention, the light detector oversamples the modulated light.

Further, in accordance with a preferred embodiment of the present invention, the light detector includes at least one angle detector. The at least one angle detector includes a linear image sensor and an optical unit facing the sensor and the optical unit includes an optical element having a curved surface and a covering on an outward surface of the optical element having a slit formed therein.

Still further, in accordance with a preferred embodiment of the present invention, the position data includes at least one of: a location of each of the at least one beacon within a two-dimensional angular frame-of-reference of the detector, a location of each of the at least one beacon within a three-dimensional frame-of-reference of the detector, a location and orientation of the detector within the frame of reference of the physical element from light from the at least one beacon and a location and orientation of the headset within the frame of reference of the physical element from light from the at least one beacon.

There is also provided, in accordance with a preferred embodiment of the present invention, a fixed map augmented reality system which includes at least one beacon, a detector on a headset and a displayer. The beacon is mounted on or integrated with a physical element and emits light modulated with fixed map data related to a location of the light-emitting element of the physical element. When viewing the beacon, the detector decodes the modulated light into the fixed map data and determines a physical relationship of the beacon with respect to the detector. The displayer uses the physical relationship to generate a display overlay on the headset of the fixed map data related to the physical element.

There is also provided, in accordance with a preferred embodiment of the present invention, a display overlay for a fixed map augmented reality system. The display overlay includes a human-readable message of data related to a physical element being viewed by a user, and a display connection connecting the human-readable message to a location in a frame-of-reference associated with the physical element.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1A is a schematic illustration of an augmented reality system, constructed and operative in accordance with a preferred embodiment of the present invention;

FIGS. 1B and 1C are schematic illustrations detailing the type of data provided by indicator units forming part of the system of FIG. 1A;

FIG. 1D is a schematic illustration of the overall visual effect observed by a user of the augmented reality system of FIG. 1A;

FIG. 2 is a block diagram illustration of an indicator unit forming part of the augmented reality system of FIG. 1A;

FIG. 3 is a block diagram illustration of a receiver forming part of the augmented reality system of FIG. 1A;

FIG. 4 is a block diagram illustration of a detector forming part of the receiver of FIG. 3;

FIGS. 5 and 6 are schematic illustrations of angle detectors forming part of the detector of FIG. 3; and

FIG. 7 is a timing diagram illustration useful in understanding the operation of the detector of FIG. 4.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Applicant has realized that the map should be built from the physical reality, and thus, the location of physical elements (or landmarks) within the map should be determined with respect to a frame of reference (FoR) defined by the landmarks. Applicant has further realized that indicator lights mounted or installed at defined locations within that FoR may be used as both as landmarks and as beacons for an augmented reality (AR) headset of a user and that a detector on the headset can use these beacons to determine the user's six degree of freedom (6DOF) pose (location and orientation) with respect to the landmarks. Moreover, Applicant has realized that, by adding modulation to the indicator lights, the indicator lights can transmit data to the detector about their location in the FoR, Applicant has realized that the indicator lights can transmit status data pertinent to their specific locality and the detector can display the status data on the headset with a display connection to the landmarks. Applicant has realized that the indicator lights can transmit additional status data pertinent to a nearby location in the same FoR and the detector can display the additional status data on the headset with a visual connection to that nearby location.

It will be appreciated that, as a result, the present invention ensures that ultimate control of the location (i.e., map) data received by the user's headset rests with those in physical control of such landmarks. It will be further appreciated that, as a result, the present invention provides a single, unified, all-optical path over which positional information is derived by the AR device and over which status information is transferred to the AR device, all in real-time.

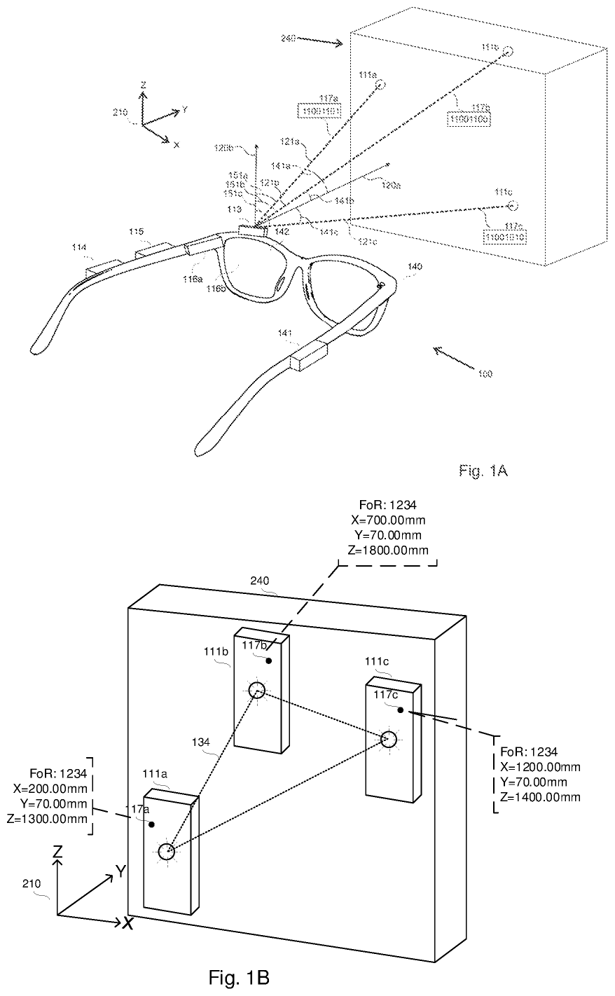

Reference is now made to FIG. 1A, which illustrates an augmented reality system 100, constructed and operative in accordance with a preferred embodiment of the present invention. Augmented reality system 100 typically comprises a set of augmented reality glasses 140 viewing a large piece of equipment 240, which may be any rigid physical element. Large piece of equipment 240 may have multiple indicator units 111a, 111b, 111c mounted thereon or formed therein. Reference is now also made to FIGS. 1B and 1C, which detail the type of data provided by indicator units 111, and to FIG. 1D which illustrates the overall visual effect that might be observed by a user wearing augmented reality glasses 140 when viewing large piece of equipment 240 with the data of FIGS. 1B and 1C.

Augmented reality glasses 140 may be any suitable set of glasses to which various AR units, such as a detector unit 113, a processing unit 114, a graphics unit 115, and a display unit 116, may be mounted, or it may be a headset having the AR units integrally formed therein. In FIG. 1A, display unit 116 comprises a projection unit 116a mounted on the arm of augmented reality glasses 140 and a reflection unit 116b incorporated into the left optical window 142 of augmented reality glasses 140, which together place an electronically-generated image in the field of view of the wearer of augmented reality glasses 140.

The augmented reality glasses 140 may typically contain other units, such as battery unit 141. They may also include an IMU (Inertial Measurement Unit), cameras, microphones, buttons, and a range of other sensor devices. They may include communications units (such as WiFi, Bluetooth, 5G Cellular). They may also include output devices such as speakers. Other units may connect to and interact with at least one of detector unit 113, processing unit 114, and graphics unit 115 to enhance the functionality of augmented reality glasses 140. The augmented reality glasses 140 may be tethered to an additional device, such as a smartphone, with elements of its functionality, such as that of processing unit 114 performed on this additional device. The tether to such an additional device may be of a wireless nature.

The user wearing augmented reality glasses 140 will observe large piece of equipment 240, and indicator units 111a, 111b, and 111c. Indicator units 111a, 111b, 111c may emit infra-red light, which may not be visible to the user, and detector 113 may detect the emitted light. Indicator units 111 may act as beacons for detection by detector unit 113.

FIG. 1A shows optical paths 121a, 121b, and 121c through which light from indicator units 111a, 111b, 111c may be received by detector unit 113. FIG. 1A also shows lines 120a and 120b that illustrate an angular frame-of-reference of detector unit 113 for incoming light. where line 120a illustrates the path at which incoming light to detector unit 113 would arrive at the normal (zero angle) to detector unit 113, and line 120b illustrates the direction in which a source of incoming light at the normal could be moved that cause a change in elevation at arrival at detector unit 113, but remain at zero azimuth.

As described in more detail hereinbelow, the optical arrangement of detector unit 113 is such as to allow the azimuth and elevation of the optical paths 121a, 121b, and 121c to be determined with respect to an angular frame-of-reference of detector unit 113 such as defined by lines 120a and 120b. Measurements 141a, 141b, and 141c each represent an azimuth value that may be determined by detector unit 113 from observed light from indicator units 111a, 111b, 111c. Likewise, measurements 151a, 151b, and 151c each represent an elevation value that may be determined by detector unit 113 from observed light from indicator units 111a, 111b, 111c respectively.

In arrangements where sub-units of detector unit 113 provide additional optical paths due to the offset positions of sub-units from each other, triangulation on the basis of differences of azimuth and elevation between sub-units (not depicted), may provide a basis for determining the distance of each of multiple indicator units 111 from detector unit 113.

In accordance with a preferred embodiment of the present invention, the light emitted by indicator units 111 may be modulated, in order to carry positional data of each indicator unit 111. Thus, as shown in FIG. 1B, the modulation for indicator unit 111a will provide positional data 117a, within a common frame-of-reference 210, the modulation for indicator unit 111b will provide positional data 117b and the modulation for indicator unit 111c will provide positional data 117c of the units.

Frame-of-reference 210 may be arbitrarily chosen, such as by the manufacturer of large piece of equipment 240 who may define its origin, for example, at a corner of the front panel of large piece of equipment 240, and its orientation, where the X direction extends horizontally to the right and the Z direction extends vertically upwards. Frame-of-reference 210 may have an associated FoR code, which may be arbitrarily chosen or may be derived from an IP address of large piece of equipment 240. The manufacturer may determine positions (X,Y,Z) of each indicator unit 111a, 111b, or 111c within frame-of-reference 210. These individual positions (X,Y,Z), along with their shared FoR. identifier (shown as “1234” in FIG. 1B), may then be recorded in the relevant indicator units 111, as described in more detail hereinbelow, for later transmission.

Applicant has realized that indicator units 111 may also provide positional information for other locations on large piece of equipment 240. These are shown in FIG. 1C, where markers 131a, 131b, and 131c are illustrated. In FIG. 1C, indicator units 111a, 111b, and 111c have been omitted for clarity. Markers 131 are not actual objects; instead, they are references to specific locations within frame-of-reference 210, where other messages may be displayed. The locations of markers 131 and their associated messages may be conveyed by data packets transmitted by indicator units 111. For example, positional and message details of markers 131a, 131b, and 131c may all be delivered by encoded optical data transmitted by indicator unit 111a.

In the example of FIG. 1C, marker 131a is contained within a triangle 134 (FIG. 1B) formed by indicator units 111, marker 131b is on the plane of triangle 134 but outside of it, and marker 131c is not on the plane at all. Markers 131 may represent a mixture of real and virtual elements; for example, markers 131a and 131b may be assigned to the position of screw heads that are to be removed, thus corresponding to real items which have no indicator of their own. As an additional example, marker 131c may be assigned to a position at which an emoji character indicating a system status, or some other pertinent message, is to be displayed, thus representing a position which may have no corresponding real physical element.

FIG. 1D shows a display area 116c of display unit 116, overlaid upon the view of large piece of equipment 240, as seen by the user through optical window 142. In this example, four electronically generated figures, 132, otherwise known as dialog boxes or human-readable message indicators, are displayed, each comprising a box 133 containing text and a pointed arrow 135 from the box to the (X,Y,Z) location of one of indicator units 111 or one of markers 131.

For example, the packet sent by indicator unit 111c may contain the message “Stat:Hot” to be displayed at the location of its light-emitting element. This may be displayed as electronically-generated FIG. 132c with a pointed arrow 135c that ends at the location of the light-emitting element of indicator unit 111c. Thus, the user may see FIG. 133c “display connected” or “visually attached” to indicator unit 111c and may therefore associate the live status information displayed therein with indicator unit 111c, for example, indicating directly to the user that the temperature at the place on which large piece of equipment 240 is mounted is unacceptably high. It will be appreciated that the display connection may connect an item to be displayed, such as box 133, with live status information or an icon, via a pointed arrow, such as arrow 135, precisely aligned with a light-emitting element in the real world. Moreover, while the item to be displayed may be in a human-readable manner, the information was provided by the light-emitting element in a non-human-readable manner.

Regarding the other three electronically-generated figures, 132a, 132b, and 132d, these are representative of messages to be displayed at the locations of marker 131a, marker 131b, and marker 131c, respectively, with such locations and messages delivered, for example, by encoded optical data coming from indicator unit 111a.

Although the marker locations need not necessarily relate to actual elements, in a typical application, they may be used to direct the user's attention to actual physical elements. For example, there may be two small screws in the large piece of equipment 240 that may need to be removed. The marker positions may be defined to be the physical locations of these screws within the FoR of large piece of equipment 240. A user wearing an augmented reality headset may be guided to these locations by means of electronically-generated FIGS. 132b and 132a that include a message regarding what operation is to be performed, together with a pointed arrow indicating the position at which it is to be performed.

It will be noted that the location of marker 131c does not correspond to any particular physical element or location within large piece of equipment 240. The position of this marker has been defined to be closer to the user than the plane of the front of large piece of equipment 240. In this example, an electronically-generated figure of 132d appearing at marker location 131c, provides an important message to the user that sticks out by appearing closer to the user than the other messages.

The information delivered to indicator unit 111a via optional status data input interface 118 may be any suitable information. For example, the information delivered could be a reference to some rich data (such as full-color picture, training video, look-up tables) which may be further processed within receiver unit 112 prior to being delivered as visible elements in the useable display area 116c of display unit 116. Likewise, this reference to rich data may include an address for location of the data through additional means (such as a universal resource locator (URL) for fetching data from the internet or an IP address for receiving additional data directly from the device incorporating indicator unit 111). Similarly a portion of the information delivered to indicator unit 111 via optional status data input interface 118 and received by receiver unit 112 may be a cryptographic key, allowing secure transfer of data between the device incorporating indicator unit 111 and the device incorporating receiver unit 112, such techniques being preferable to existing techniques for secure connection establishment based on physical proximity such as WPS and NFC.

It will be clear that whilst the display connection may be formed by pointed arrow 135, alternative forms of display connection may be used. For example, as an alternative to pointed arrow 135, other techniques such as a circle, cross-hairs, color highlighting, and so-forth may be used to indicate the desired precise location to be shown to the user.

Although the illustration of FIG. 1D indicates a single eyepiece of an augmented reality system, in many augmented reality systems, there may be a display unit in front of each eye, and electronically-generated figures may be placed in each display unit. Typically, for each electronically generated FIG. 132, careful introduction of small opposing horizontal offsets of this figure relative to each eye allows control of the user-perceived distance of this figure from the user. Likewise, in many cases, and even where stereoscopic displays are not provided, it will be desirable that electronically-generated FIGS. 132 appear to the user in a size that correctly reflects the distance at which the figure is to appear from the user. It will be appreciated that for these reasons, it is useful that the techniques described allow the derivation in three lateral dimensions of the relative position at which electronically-generated FIGS. 132 are to be displayed.

It will be appreciated that, by putting indicator lights on physical elements within an area and by defining the locations of the indicator lights within a shared frame of reference attached to that area, the map information of the real world stays fixed irrespective of influencing factors such as headset movement, order in which elements of the area are observed by headset mechanisms, re-initialization of headset, and so forth. It will be further appreciated that multiple headsets operating in the same area, for example worn by multiple users, will receive and derive identical map information. Furthermore, it will be appreciated that an area may be defined as encompassing a large piece of equipment, such as the airframe of an airplane, and that the area may be moved together with its attached indicators without requiring any adjustment to the positional data stored for each indicator unit 111. Furthermore, according to a preferred embodiment of the present invention, the indicator lights provide not only information to be displayed, but information to display connect it to a fixed place in the real world.

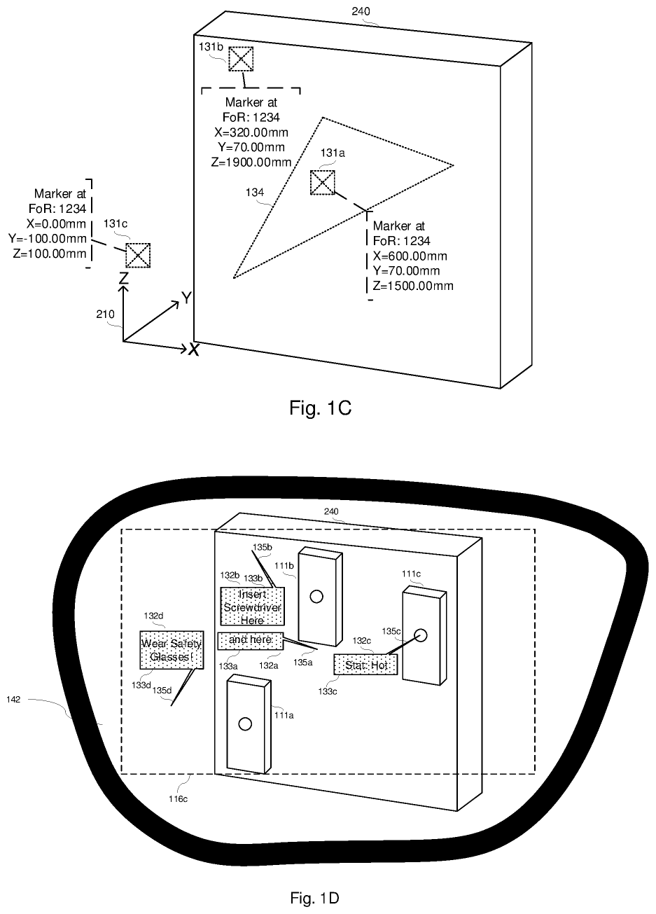

Reference is now made to FIG. 2, which details the elements of each indicator unit 111. Each indicator unit 111 comprises a data assembly unit 160, a modulation generation unit 166, a power driver unit 167 and a light emitting unit 168. Data assembly unit 160 creates a digital data stream which includes at least positional data 117, which, as discussed hereinabove, includes frame-of-reference 210 and location (X,Y,Z) in frame-of-reference 210. Modulation generation unit 166 converts the digital data stream into at least one varying electrical signal and power driver unit 167 powers light emitting unit 168 according to the varying electrical signal. Thus, light emitting unit 168 emits modulated light according to the digital data stream.

In a preferred embodiment, data assembly unit 160 creates packets of data to be sent as part of the digital data stream and comprises a fixed data storage unit 161, a positional data storage unit 162, an optional status data storage unit 163, and an optional forward error calculation unit 164.

In a preferred embodiment, fixed data storage unit 161 may store standardized pieces of data that do not change over time and do not change between similar indicator units, such as a packet start, a packet stop, fixed header values, and data idle indications. Positional data storage unit 162 may store positional data 117, which does not change over time but may differ between similar indicator units and may be delivered to data assembly unit 160, typically by the manufacturer, over a positional data configuration interface 169, such as an SPI (Serial Peripheral Interface protocol) or any similar interface.

Optional status data storage unit 163 may store details of status indications relevant to large piece of equipment 240, such as local temperature, operational abnormalities, consumable material levels and so forth. The status indications may be delivered via an optional status data input interface 118 from a source external data assembly unit 160, such as from some part of large piece of equipment 240. Optional forward error calculation unit 164 may receive the output of fixed data storage unit 161, positional data storage unit 162, and optional status data storage unit 163 and may generate forward error information (such information may comprise at least one of checksum, Cyclic Redundancy Check, Hamming codes, SECDED, convolutional codes, Turbo Codes, and other Forward Error Correction codes). This forward error information may assist processing unit 114 in determining that errors have been introduced in the communication channels, and in some implementations may allow a limited number of such errors to be corrected.

Data sequencer unit 165 may combine the output of fixed data storage unit 161, positional data storage unit 162, optional status data storage unit 163, and optional forward error calculation unit 164 into a combined stream of output data. Data sequencer unit 165 may encode the combined stream for modulation by modulation generation unit 166.

In a preferred embodiment, modulation generation unit 166 may, in addition to the data signal, receive a clock signal, such as a 960 Hz clock signal, from data assembly unit 160. Modulation generation unit 166 may, on receipt of a rising clock edge from modulation generation unit 166 indicating that an updated data bit has been presented by data assembly unit 160, modulate its output data value:

where a ‘1’ value was received from data assembly unit 160, it may drive ‘1’ value towards power driver unit 127 for 122.88 us, and then to drive a ‘0’ value;

where a ‘0’ value was received from data assembly unit 160, it may drive ‘1’ value towards power driver unit 127 for 327.68 us, and then to drive a ‘0’ value;

In such a manner, modulation generation unit 166 may convert the data received from data assembly unit 160 into a pulse-width modulated varying electric signal to power driver unit 167.

Typically, the data will be modulated by the combination of modulation generation unit 166 and power driver unit 167 into changes in light intensity occurring in excess of one hundred and fifty times per second. The modulation may take many forms, including PWM, PPM, FM, QPSK, QAM and so forth.

In the preferred embodiment, power driver unit 167 may be formed according to the “Typical Applications Circuit” described in the technical literature for the AL8843 SP-13 40V 3A STEP-DOWN LED DRIVER offered by Diodes Incorporated of Tex., USA, and light emitting unit 128 may be the SFH 4770S A01 850 nm Infra-Red LED provided by the OSRAM group of Munich, Germany mounted on a PCB with good thermal conductivity to provide heat dissipation.

According to an alternate embodiment, light emitting unit 168 may be formed by LEDs of different wavelengths, including LEDs emitting light in the visible spectrum. Likewise, other light-emitting devices (for example, VCSEL) may be used. The applied modulation may be used to affect light emitting unit 168 in other ways, such as affecting its color (chromaticity), polarization, and so forth.

According to yet another alternate embodiment, light emitting unit 168 may not emit light of its own generation but may instead modulate the transmission of light produced elsewhere. In some implementations, it may be possible for light emitting unit 168 to receive the signal of modulation generation unit 166 directly without the need for a power driver unit 167. The light produced elsewhere may be provided to light emitting unit 168 via light fiber (fiber optic), light pipe and similar means. Similarly, the light produced elsewhere may be emitted by a light source mounted close to detector unit 113 of receiving unit 112, and may be returned by a retro-reflector provided as part of light emitting unit 168 of indicator unit 111 whose optical characteristics are modulated by a component such as an LCD shutter in light emitting unit 168.

It will be clear that light transfer devices such as light fiber (fiber optic) and light pipe allow light to be emitted from a location different to that of light emitting unit 168. Where an arrangement such as this is used, positional data 117a provided to positional data storage unit 162 may reflect the position of the emitting end of the light transfer device.

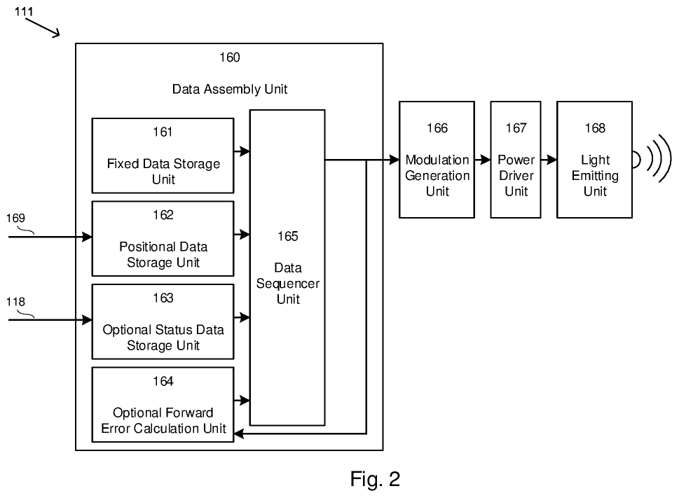

Reference is now made to FIG. 3, which illustrates a receiving unit 112 comprising detector unit 113, processing unit 114 and graphics unit 115.

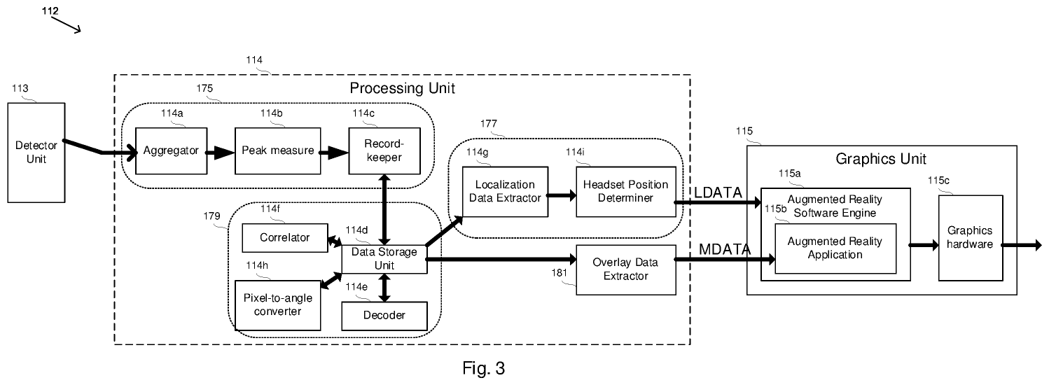

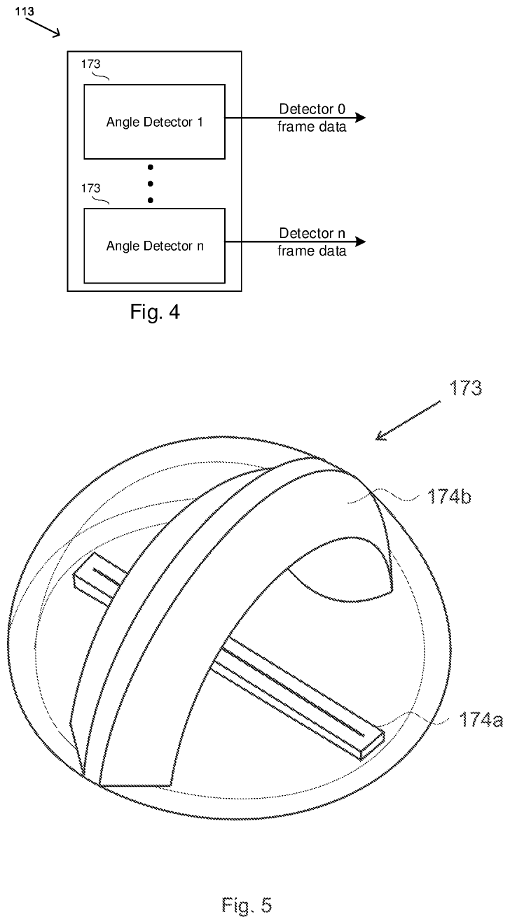

According to a preferred embodiment, detector unit 113 may be any detector unit capable of independently capturing modulated light from multiple angles and of reporting it in a streaming manner. For capturing light from multiple angles, detector unit 113 may measure light levels as a function of the angles at which it receives light. As shown in FIG. 4, to which reference is briefly made, detector unit 113 may comprise a number of angle detectors 173 of the types described in U.S. Pat. No. 10,511,794, entitled “WIDE FIELD OF VIEW OPTICAL MODULE FOR LINEAR SENSOR”, owned by Applicant and incorporated herein by reference. Each angle detector 173 may be formed of a high speed, linear image sensor with an optical unit facing the sensor. The optical unit may include an optical element having a curved surface and a covering on an outward surface of the optical element. The covering may have a slit formed therein. A suitable arrangement for an angle detector 173 is shown in FIG. 5, to which reference is now briefly made, which shows high speed linear image sensor 174a with an optical unit 174b facing sensor 174a.

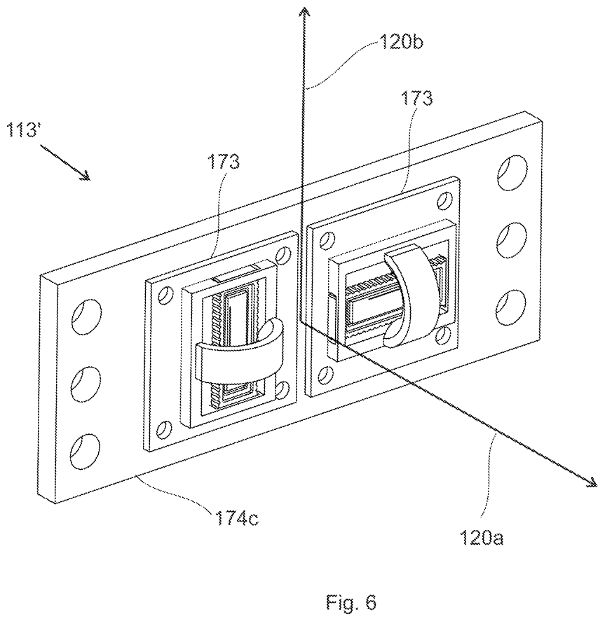

In one embodiment, angle detectors 173 may each be aligned to a different axis, which may be a range of axes rotated relative to each other by simple fractions of a 360-degree rotation. One such embodiment is illustrated in FIG. 6, to which reference is now briefly made, with detector unit 113′ formed from two angle detectors 173 mounted at 90 degrees to each other, on a rigid plate, such as carbon-fiber plate 174c. Alternatively or in addition, angle detectors 173 may be at non-orthogonal angles to each other and at offsets in position such as to allow a triangulated distance to light sources to be calculated. An exemplary positioning calculation using angle detectors 173 is described in U.S. Pat. No. 10,718,603, incorporated herein by reference and owned by Applicant.

According to an alternate embodiment, detector unit 113 may be formed by at least one high-speed 2D camera, having a mechanism to process the image data in such a manner that the optic characteristics (such as intensity) of certain parts of the 2D image received may be detected and reported at high speed (over 150 FPS) without requiring the entire image to be reported by the camera. Such data reduction techniques may include region-of-interest, averaging over multiple pixels, edge detection algorithm and background subtraction mechanisms. Where there is in excess of one such 2D camera, each may be considered a sub-unit of detector unit 113, and the offset positions of the sub-units from each other may permit triangulation as described above.

According to an alternate embodiment, detector unit 113 may be formed by at least one event camera, reporting details of those pixels whose intensity changes, used to detect and report high-speed speed (over 150 FPS) changes in the 2D image received. Similarly, multiple event cameras may each be considered a sub-unit of detector unit 113, together capable of permitting triangulation of received light.

According to a preferred embodiment, detector unit 113 may capture light at a frame rate higher than the rate at which data is being sent by indicator units 111, using a technique called oversampling. This may be necessary since indicator units 111 may use pulse width modulation (i.e. transmitting pulses) which may not be synchronized with the frame rate of detector unit 113), and detector unit 113 may capture light at a frame rate high enough to ensure full exposure of one pulse of emitted light for at least one exposure time. For example, indicator units 111 may send modulated light pulses as short as 122.88 us and detector unit 113 may have an exposure time of under 40.96 us and a time for conversion to light level reading values and recovery of at least 40.96 us, providing a frame repeat time of 81.92 us (frame rate of 12,207 FPS). Thus, with no requirement for synchronization between detector unit 113 and any of indicator units 111, no matter when a light pulse from indicator unit 111 starts, at some point during its transmission, pulse detector unit 113 will be available to capture it for at least one full exposure.

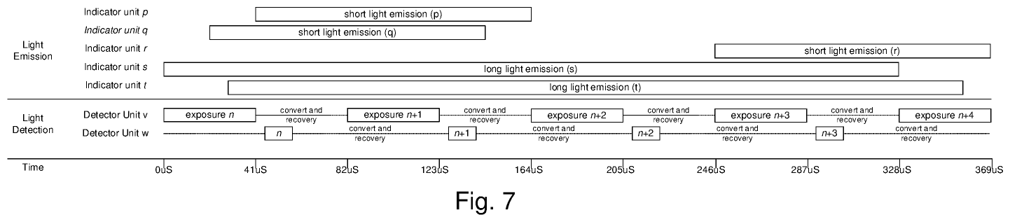

The oversampling approach is illustrated in the timing diagram of FIG. 7, to which reference is now briefly made. FIG. 7 illustrates the timing that may result from five independent examples of indicator unit 111 (whose light emissions timings are marked p, q, r, s and t), and two independent units of detector unit 113 (whose light detection timings are marked v and w). Light emissions p, q, and r are short light pulses, of duration 122.88 us, and light emissions s and t are long light pulse of 327.68 us. As previously discussed, a new light pulse, short or long, may be sent by any indicator unit at a rate of one every 1041 us (960 BAUD), and this may be according to the indicator unit's own timing. For the purpose of illustration, the light pulses of indicator units 111 are shown starting within 250 us of each other.

FIG. 7 further illustrates that the exposure time for a detector unit with timing v is 40.96 us, and that the exposure time for a detector unit with timing w is a shorter time of 12.2 us which may be chosen to compensate for stronger light levels being received at this detector unit.

As can be seen, the short light emission p would be fully captured by exposure n+1 of a detector unit with timing v. It would also be fully captured by exposures n and n+1 of a detector with timing w. Likewise, the short light emission q would be fully captured by exposure n+1 of a detector unit with timing v and by exposures n and n+1 of a detector with timing w. Likewise, the short light emission from an indicator unit with timing r would be fully captured by exposures n+3 and n+4 of a detector unit with timing v and by exposure n+3 of a detector with timing w. For all these cases, a short light pulse is fully exposed for between 1 and 2 sequential exposure windows. It will be noted that a short light pulse does not deliver any light into any more than two exposure windows, thus ensuring that, for a short pulse, it will never be determined that more than two exposure windows were fully-exposed.

Similarly, long light pulse s is fully captured by exposures n, n+1, n+2, and n+3 of detectors with timing v and w, while long light pulse t is fully captured by exposures n+1, n+2, n+3 of detectors with timing v and of exposures n, n+1, n+2, n+3 of detectors with timing w. It will be noted that in some cases, the beginning or end of light pulses occur during an exposure, for example, long light pulse t begins during exposure n and ends during exposure n+4 of a detector with timing v. The partial exposure during these exposure windows is likely to result in a lower level of received light, which could result in them being incorrectly determined to be fully-exposed. However, such additional determinations need not detract from the correct determination of full exposure during at least three exposures, in this case during exposures n+1, n+2, n+3.

Returning to FIG. 3, processing unit 114, may, for each of the angles at which modulated light levels are indicated by detector unit 113, keep track of the changing light levels from exposure to exposure, for example determining whether a short (such as 122.88 us) light pulse was emitted (determined to be fully-exposed for between 1 and 2 frames) or a long light pulse (such as 327.68 us) was emitted (determined to be fully-exposed for at least 3 frames).

Processing unit 114 may comprise a data receiver 175 to receive and determine the signals from detector unit 113, a headset pose determiner 177 to determine the location in space and orientation of the user's head, a report management unit 179 and an overlay determiner 181 to determine where to locate FIGS. 132.

Data receiver 175 comprises an aggregator 114a, a peak measurer 114b, and a record keeper 114c. Aggregator 114a may receive the signals from the multiple angle detectors 173 of detector unit 113. Peak measurer 114b may identify peaks within the signals which denote the light received during pulses of indicator units and, from this, may capture details of the angle detector 173 and of the pixels within that angle detector 173 at which light pulses were received, such as from indicator units 111. Peak measurer 114b may group the readings of adjacent pixels that detected a light pulse into a single report. By use of mathematical techniques such as interpolation, peak measurer 114b may determine the center point of a detected light pulse to a resolution that is finer than the size of a single pixel, Likewise, peak measurer 114b may determine additional parameters, such as peak width, peak intensity, peak edge sharpness, and so forth. Peak measurer 114b may provide the identified angle detector and pixel information to record keeper 114c to be passed to report management unit 179. As a result, report management unit 179 may hold a record of currently-and-recently-observed pixel locations.

Record keeper 114c may update the information it has provided to the records in report management unit 179 as desired. For example, it may store them as a function of: i) associating the pixel locations with recently reported observed locations, and updating the record for those, ii) creating a new record for locations that are not identified as recently reported observed pixel locations, iii) removing those observed pixel locations that remain unreported for many successive reports, and iv) invalidating those observed pixel locations whose received light pattern is atypical of indicator units 111.

Report management unit 179 may comprise a data storage unit 114d, a decoder 114e, a correlator 114f and a pixel-to-angle converter 114h. Data storage unit 114d may be an array of data held in random-access memory. Data storage unit 114d may hold the records provided by record keeper 114c. Decoder 114e may access these records in data storage unit 114d to decode the lights pulses at particular positions into a digital data stream, to decode the light pulses into transmitted packets of data, and to store the details of the decoded data stream (such as XYZ coordinates or ID) in a suitable manner in data storage unit 114d, for example, alongside the records maintained by record keeper 114c in data storage unit 114d. Decoder 114e may perform manipulation on the decoded data stream, such as applying error-correcting algorithms, checking for consistency over multiple packets, and so forth, so as to identify and disqualify incorrect reception from indicator units 111 and to identify and disqualify spurious data from sources other than indicator units 111.

Correlator 114f may access the records in data storage unit 114d to derive, by means of correlating between the data streams and/or packets, that light pulses from specific indicator units 111 were detected by more than one angle detector 173 unit. Correlator 114f may record these correlations in data storage unit 114d.

Pixel-to-angle converter 114h has received apriori calibration data pertaining to the optical characteristics of detector unit 113. Using this calibration data, converter 114h may convert the angles at which the correlated light pulses from each indicator unit 111 arrived at detector unit 113, for example, alongside the correlations stored by correlator 114f Based on the mechanical arrangement of angle detectors 173 and the mechanical offset between them, pixel-to-angle converter 114h may also provide a calculated distance from each indicator unit 111 to detector unit 113. Pixel-to-angle converter 114h may take into account the readings of light pulses received at multiple angle detectors 173, for example, according to the correlations provided by correlator 114f, to enable multi-dimensional calibrations to be applied in the pixel-to-angle process on the basis of being able to apply initial angular determinations made from data provided by at least one of angle detectors 173 to the calibration process applied for determining angular determinations for another of angle detectors 173. This multi-dimensional calibration process may be implemented in an iterative manner.

Headset determiner 177 may comprise a localization data extractor 114g and a headset position determiner 114i. Localization data extractor 114g may continually extract details of the correlated light sources from data storage unit 114d (or may receive these details in real-time) and may provide the correlation, angle, and decoded details such as XYZ coordinates for each correlated light source to headset position determiner 114i

Headset position determiner 114i may utilize multiple sets of reports from localization data extractor 114g to derive the 6DOF position of detector unit 113 within frame of reference 210. Each report may typically contain angular and, where available, distance information derived by pixel-to-angle converter 114h for a particular indicator unit 111, together with the location XYZ received in the data packets from that particular indicator unit 111.

Headset position determiner 114i may use a combination of triangulation and trilateration to derive an initial 6DOF position of detector unit 113, and may then continue to recalculate the 6DOF position using SLAM techniques, such as an Extended Kalman Filter, to update the 6DOF position as updated reports become available.

Headset position determiner 114i may provide a constantly updated 6DOF value representing the position of detector unit 113 within frame of reference 210 as location data LDATA to graphics unit 115.

Alternatively, based on its knowledge of the mechanical arrangement of the augmented reality device into which it is incorporated, headset position determiner 114i may determine the position of another part of the augmented reality device, such as the position of the glasses nose bridge within frame of reference 210, and may provide it as location data LDATA.

Overlay data extractor 114j may continually extract from data storage unit 114d (or may receive these details in real-time), one or more details of the decoded data stream, together with the XYZ anchor position for those details within frame-of-reference 210, and may deliver them as message data MDATA, to graphics unit 115. Information provided in MDATA may pertain both to indicator units 111 and to markers 131.

Graphics unit 115 may be a computing unit, such as a System-On-Chip, that runs the software of an augmented reality engine 115a. An exemplary such engine could be the “Unity” Augmented Reality engine or the “Unreal” Augmented Reality engine.

Augmented reality engine 115a may receive headset position data (i.e. location data LDATA) within frame of reference 210. Augmented reality engine 115a may also run an Augmented reality application, such as applications that may be written to operate under the “Unity” Augmented Reality engine.

Augmented reality application 115b may be designed to receive details of virtual objects, such as the human-readable message indicators 132 which are part of message data MDATA, to be placed virtually as an overlay within the field-of-view of the wearer of AR glasses 140, and to be anchored to a specific position within frame-of-reference 210.

Graphics unit 115 may also contain graphics hardware 115c capable of driving the output of augmented reality engine 115a to display 116c.

It will be clear that the data flow depicted for processing unit 114 in FIG. 3 is one example of a possible data flow, in which data storage unit 114d is accessed by multiple elements which read and update the data held within it. Alternate embodiments of the invention may also be implemented.

For example, a pipeline-style flow may be implemented whereby record-keeper 114c may pass to decoder 114e all the data that is required to perform the decoding task, together with details of updates, additions, and removals of recently reported observed pixel locations. Decoder 114e may pass to correlator 114f all the data that is required to perform the correlating task for recently reported observed pixel locations, together with up-to-date pixel location values and extracted XYZ coordinates from the data stream. Correlator function 114f may pass this data, together with its derived correlation data, to localization data extractor 114g, which may arrange the data accordingly for delivery to pixel-to-angle converter 114h. Pixel-to-angle converter 114h may deliver angle-converted values together with the data first provided by decoder 114e to headset position determiner 114i, and, where appropriate, to overlay data extractor 181. In such an example, decoder 114e may also pass the extracted XYZ coordinates and message data to overlay data extractor 181.

It will also be clear that alternate implementations exist whereby parts of the functionality of some parts of the data flow may be performed elsewhere in the data flow and that some parts of the data flow may be optimized by performing the same task redundantly in multiple places in the data flow. As an example, the functionality of aggregator 114a may be included as part of detector unit 113.

It will further be understood that, in some embodiments of the flow, it will be advantageous to split some parts of the functionality into multiple sub-parts which are distributed in multiple stages of the flow. For example, the task of identifying correlation could be provided partly by detection of non-correlation early in the flow with the identification of non-matching light pulses coming from different angle detectors 173 of detector unit 113, together with a determination of correlation later in the flow in terms of matching outputs from decoder 114e.

In some embodiments of the flow, a more direct approach may be taken whereby the full 6DOF of the augmented reality device need not be calculated, but instead the XYZ positional offset relative to the detector units 113 at which virtual objects, such as electronically generated FIGS. 132, are to be placed in the user's field-of-view. Such an arrangement will typically not display electronically generated FIGS. 132 orientated relative to a fixed frame-of-reference, but instead orientated according to the axes of the augmented reality device, similar to lines 120a and 120b of FIG. 1A. In some situations this may be advantageous; for example, textual messages may appear to be always orientated to face the user head-on, even if the user is observing the indicator unit 111 from an oblique angle.

Embodiments of this direct approach may make do without the LDATA data path, and instead have overlay data extractor 181 extract angle, and where available, distance information from data storage unit 114d for those indicator units 111 that are in view, and may provide details of the decoded data stream, together with angular anchor position and, optionally, distance information at which information pertaining to indicator units 111 may be displayed, expressed in terms of the frame-of-reference of the headset. This position may also be provided in terms of XYZ positional offset expressed in terms of the frame-of-reference of the headset. Overlay data extractor 181 and may deliver them as message data MDATA to graphics unit 115. Data provided to graphics unit 115 in such a format may be limited in its ability to provide an orientation according to frame of reference 210, and may be limited in its ability to provide position or orientation data for markers 131.

Returning to FIG. 2, data assembly unit 160 may form a packet encoded in 5B symbols, for example according to the 4B5B scheme of the fiber distributed data interface (FDDI) protocol, with the packet including the following fields:

a start-of-packet indication represented by the 5B symbols J and K,

an 8-bit packet type value sent as two 5B symbols,

a sixteen-bit frame-of-reference identifier represented by four 5B symbols,

three sixteen-bit position within frame-of-reference values using a total of twelve 5B symbols,

a eight-bit message sequence indicator using two 5B symbols

eight eight-bit message bytes represented by sixteen 5B symbols

sixteen checksum bits represented by four 5B symbols, and

an end-of-packet indication represented by the 5B symbols T and R.

A packet containing the fields described above may require forty-four 5B symbols, being a total of 220 data bits. Allowing for additional idle (5B symbol I) data bits, this packet may be encoded by data assembly unit 160 operating at 960 BAUD for transmission by light emitting unit 168, in under one quarter of a second.

In the preferred embodiment, the three position values of the fields may represent offsets of X,Y,Z orthogonal axes within frame-of-reference 210, defining a position of +/−32767 mm from the zero point of frame of reference 210 in each axis.

In the preferred embodiment, the message sequence indicator may be used to indicate multiple messages delivered by indicator unit 111. For example, data assembly unit 160 may alternate between packets with different messages. For example, it may alternate by sending a packet with message sequence 0 which may indicate “overall status” every second packet and sending packets with other sequences values at lower intervals, thus ensuring that the important “overall status” packets are broadcast at least every half-second with less important packets broadcast less frequently.

It will be clear that data provided via optional status data input interface 118 need not be specifically anchored to the physical position of the relevant indicator unit 111. In a preferred embodiment, alternate packet formats may be created, where packet formats containing status data pertaining to other physical positions within frame of reference 210 may include a specification of the physical position to which they are relevant, for example to implement the markers 131. These and other alternate packet formats may be interleaved with a packet format that provides status data pertaining to the position of the relevant indicator unit 111.

In an alternate embodiment, the message may be modified to include an identification number such as a locally-unique sixteen-bit ID value. This may be helpful in simplifying the workload of processing unit 114. Additionally, the use of such ID values may simplify the implementation of alternate packet formats which include the ID but not the three sixteen-bit position fields, to be transmitted interspersed with the packet format described above, providing a possible enhancement of useful data rate.

Additional enhancements may be provided using this messaging scheme. For example, where indicator units 111 are operating on battery power, they may provide an indication of the remaining battery charge. Similarly, indicator units 111 may provide information not directly related to a large piece of equipment 240, but may instead provide information pertinent to their location, such as sunlight levels or wind speeds.

While the data stream used has been described in terms of packets, it will be clear that this stream may also be delivered in a non-packetized manner, for example, as a stream of token-value pairs. Tokens may be unique, with each token indicating the particular data element (such as FoR identifier), that is carried by the immediately following value.

Unless specifically stated otherwise, as apparent from the preceding discussions, it is appreciated that, throughout the specification, discussions utilizing terms such as “processing,” “computing,” “calculating,” “determining,” or the like, refer to the action and/or processes of a general purpose computer of any type, such as a client/server system, mobile computing devices, smart appliances, cloud computing units or similar electronic computing devices that manipulate and/or transform data within the computing system's registers and/or memories into other data within the computing system's memories, registers or other such information storage, transmission or display devices.

Embodiments of the present invention may include apparatus for performing the operations herein. This apparatus may be specially constructed for the desired purposes, or it may comprise a computing device or system typically having at least one processor and at least one memory, selectively activated or reconfigured by a computer program stored in the computer. The resultant apparatus when instructed by software may turn the general purpose computer into inventive elements as discussed herein. The instructions may define the inventive device in operation with the computer platform for which it is desired. Such a computer program may be stored in a computer readable storage medium, such as, but not limited to, any type of disk, including optical disks, magnetic-optical disks, read-only memories (ROMs), volatile and non-volatile memories, random access memories (RAMs), electrically programmable read-only memories (EPROMs), electrically erasable and programmable read only memories (EEPROMs), magnetic or optical cards, Flash memory, disk-on-key or any other type of media suitable for storing electronic instructions and capable of being coupled to a computer system bus. The computer readable storage medium may also be implemented in cloud storage.

Some general purpose computers may comprise at least one communication element to enable communication with a data network and/or a mobile communications network.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A beacon for an augmented reality system, the beacon comprising:
a light emitting unit to emit light, said light emitting unit being mounted on or integrated with a physical element; and
a modulator to modulate said light with data related to said physical element, wherein said data comprises status data related to a status of said physical element and position data regarding a location of said light emitting unit in a frame of reference (FoR) related to said physical element.

2. The beacon according to claim 1 wherein said data also comprises marker data related to a marker location within said FoR.

3. The beacon according to claim 2 wherein at least one of said marker data and said status data comprises an internet link.

4. The beacon according to claim 1 wherein said modulator provides non-human-readable modulation.

5. The beacon according to claim 2 and also comprising a storage unit storing an ID for said FoR, and at least one of: said position data and said marker data.

6. A detector located on a headset for an augmented reality system, the detector comprising:
a light detector to capture multiple measurements at multiple angles of modulated light received from multiple angles, wherein said modulated light is emitted by at least one beacon mounted on or integrated with a physical element viewable in a direction said headset faces;
a decoder to decode said modulated light into data related to said physical element;
a processing unit to determine from said multiple angles a physical relationship of said at least one beacon with respect to said detector; and
a displayer to use said physical relationship to generate a display overlay on said headset of said data related to said physical element wherein said display overlay comprises at least one display connection to said at least one beacon.

7. The detector according to claim 6 wherein said data comprises at least one of: status data related to a status of said physical element, position data regarding a beacon location of said at least one beacon in a frame of reference (FoR) related to said physical element, and marker data and marker location data related to at least one marker location within said FoR.

8. The detector according to claim 6 wherein at least said data comprises an interne link.

9. The detector according to claim 7 wherein said at least one beacon is three or more beacons and said physical element is a rigid element.

10. The detector according to claim 6 wherein said display overlay comprises a human-readable message of said data connected to said at least one display connection.

11. The detector according to claim 9 wherein said display overlay comprises, for at least one beacon location of said three or more beacons, a human-readable message of said status data related to said beacon location connected by said at least one display connection to said beacon location.

12. The detector according to claim 7 wherein said display overlay comprises, for said at least one marker location, a human-readable message of said marker data connected by said at least one display connection to said marker location.

13. The detector according to claim 6 and wherein said at least one display connection is a pointed arrow.

14. The detector according to claim 6 wherein the light detector oversamples said modulated light.

15. The detector according to claim 7 wherein said light detector comprises at least one angle detector.

16. The detector according to claim 15 wherein each angle detector of said at least one angle detector comprises a linear image sensor and an optical unit facing said sensor.

17. The detector according to claim 16 wherein said optical unit comprises an optical element having a curved surface and a covering on an outward surface of the optical element having a slit formed therein.

18. The detector according to claim 7 and wherein said position data comprises at least one of:
a location of each of said at least one beacon within a two-dimensional angular frame-of-reference of said detector, a location of each of said at least one beacon within a three-dimensional frame-of-reference of said detector, a location and orientation of said detector within said frame of reference of said physical element from light from said at least one beacon and a location and orientation of said headset within said frame of reference of said physical element from light from said at least one beacon.

19. A fixed map augmented reality system comprising:
at least one light-emitting beacon mounted on or integrated with a physical element and emitting light modulated with fixed map data related to a location of said light-emitting element of said physical element;
a detector on a headset to, when viewing said at least one light-emitting beacon, decodes said modulated light into said fixed map data and determine a physical relationship of said at least one light-emitting beacon with respect to said detector; and
a displayer to use said physical relationship to generate a display overlay on said headset of said fixed map data related to said physical element wherein said display overlay comprises at least one display connection to said at least one light-emitting beacon.

20. A display overlay for a fixed map augmented reality system, the display overlay comprising:
a human-readable message of data related to a physical element being viewed by a user; and
a display connection connecting said human-readable message to a location in a frame-of-reference associated with said physical element.
